(19) United States
(12) Patent Application Publication
(10) Pub. No.: US 2023/0036044 A1
(43) Pub. Date: Feb. 2, 2023

(54) MANUFACTURING METHOD OF TIRE HAVING SENSOR CONTAINER AND TIRE MANUFACTURED BY THE SAME

(71) Applicant: HANKOOK TIRE & TECHNOLOGY CO., LTD, Seongnam-si (KR)

(72) Inventors: Byung Lip KIM, Daejeon (KR); Kwang Yong LEE, Sejong-si (KR)

(21) Appl. No.: 17/876,029

(22) Filed: Jul. 28, 2022

(30) Foreign Application Priority Data
Jul. 28, 2021 (KR) 10-2021-0099124

(51) Int. Cl. B29D 30/00; B60C 19/00

(52) U.S. Cl. CPC B29D 30/0061; B60C 19/00; B60C 2019/004; B29D 2030/0072

(57) ABSTRACT

A method for manufacturing a tire having a sensor container and a tire manufactured by the manufacturing method, and more particularly, a method for manufacturing a tire having a sensor container for preventing the sensor container from falling off during high-speed driving, and a tire manufactured by the manufacturing method are proposed. The method for manufacturing a tire having a sensor container, includes the steps of a) curing a container unit; b) forming a dummy by filling an inside of the cured container unit with a dummy material in which urethane and a curing agent are mixed; c) attaching the container unit including the dummy formed by curing to a tire; d) curing the tire to which the container unit is attached; e) removing the dummy included in the container unit attached to the cured tire; and f) mounting a sensor at a position where the dummy is removed.

### CROSS REFERENCE TO RELAYED APPLICATION

The present application claims priority to Korean Patent Application No. 10-2021-0099124, filed Jul. 28, 2021, the entire contents of which is incorporated herein for all purposes by this reference.

### BACKGROUND OF THE INVENTION

### Field of the Invention

The present invention relates to a method for manufacturing a tire having a sensor container and a tire manufactured by the manufacturing method, and more particularly, to a method for manufacturing a tire having a sensor container for preventing the sensor container from falling off during high-speed driving, and a tire manufactured by the manufacturing method.

Description of the Related Art

Recently, various methods for attaching sensors to the inside of a tire have been devised in order to receive tire status information directly related to the safety of vehicle occupants in real time.

Products sold in the actual market are released in a way that adhesives are applied to an inner liner rubber inside a cured finished tire and then a cured container having a sensor is attached.

However, this method causes variations in the ambient environment such as temperature, pressure, and climatic conditions at the time of application of the adhesive, the amount of application and the magnitude of the force applied for adhesion.

Accordingly, as the heat generated from a tread is transmitted to the inside of the tire during high-speed driving, voids are occurred in the adhesive between the inner liner portion and the sensor container. As the voids occurred in this way gradually expanded, the movement of the sensor increased, making accurate sensing difficult. Further, in severe cases, there was a problem in that the adhesive was peeled off and the sensor inside the tire was damaged, damaging the tire and endangering the safety of the occupants.

In addition, since the use of adhesives is related to environmental pollution, it does not follow the policies of each tire manufacturer that are currently aiming for eco-friendly products.

In addition to this, for example, a method including curing a patch on the inner liner of a tire or forming a groove in the inner liner to attach a patch and curing, and then, removing the patch to insert a sensor has been proposed. However, since these technologies are often not practically applicable due to the complicated manufacturing process, in most cases, the container having sensors is attached to the inner liner using an adhesive.

Therefore, there is a need to develop a technology capable of permanently fixing a sensor container to a tire without using an adhesive while a manufacturing process is simple.

### DOCUMENTS OF RELATED ART

(Patent Document 1) Korean Registered Patent No. 1418214

### SUMMARY OF THE INVENTION

An object of the present invention to solve the above problems is to provide a method of manufacturing a tire having a sensor container for preventing the sensor container from falling off during high-speed driving, and a tire manufactured by the manufacturing method.

The technical objects to be achieved by the present invention are not limited to the technical objects mentioned above, and other technical objects not mentioned can be clearly understood by those of ordinary skill in the art to which the present invention belongs from the description below.

The configuration of the present invention for achieving the above object provides a method for manufacturing a tire having a sensor container, including a) curing a container unit; b) forming a dummy by filling an inside of the cured container unit with a dummy material in which urethane and a curing agent are mixed; c) attaching the container unit including the dummy formed by curing to a tire; d) curing the tire to which the container unit is attached; e) removing the dummy included in the container unit attached to the cured tire; and f) mounting a sensor at a position where the dummy is removed.

In an embodiment of the present invention, in the step a), the container unit may be prepared to contain 0.1 to 99.5% by weight of a filler material, 0.1 to 99.5% by weight of oil, and 0.001 to 30% by weight of sulfur.

In an embodiment of the present invention, the filler material may be made of a rubber-based material formed of a polymer mixture containing natural rubber and synthetic rubber, and may be made of any one or more of carbon, silica, and organic filler.

In an embodiment of the present invention, the oil may be a vegetable oil or a petroleum oil.

In an embodiment of the present invention, in the step a), the container unit may be provided to be cured at a temperature of 170° C. to 190° C. for 110 seconds to 130 seconds.

In an embodiment of the present invention, in the step b), the dummy material may be formed by mixing the urethane having a hardness of 1 to 100 and the curing agent in a ratio of 2:8 to 8:2.

In an embodiment of the present invention, in the step c), the container unit may be provided to be attached to any point inside the tire having an inner liner.

In an embodiment of the present invention, in the step d), the curing may be performed such that the container unit has a hardness of 10 to 100 and 100% modulus of 50 kgf/cm² or less.

In an embodiment of the present invention, in the step f), the sensor may be provided to be inserted into the container unit without applying an adhesive.

In an embodiment of the present invention, after the step f), the removed dummy may be provided to be recycled in the step c) and the step d) by omitting the step a) and the step b).

The configuration of the present invention for achieving the above object provides a tire manufactured by the method of manufacturing a tire having a sensor container, including the container unit cured and coupled to the tire; and the sensor inserted into the container unit.

In an embodiment of the present invention, the container unit may include a container side wall provided such that a lower portion thereof is integrated with the tire during the curing; a sensor mounting region formed inside the container side wall and formed of an empty space having a shape corresponding to an outer shape of the sensor; a container cover formed to cover an upper portion of the container side wall; and a sensor insertion hole formed in a central portion of the container cover.

In an embodiment of the present invention, a diameter of the sensor insertion hole may be provided to form a passage through which the sensor is inserted into the sensor mounting region and the container cover may be formed to fix the sensor inserted into the sensor mounting region not to be detached while driving.

The effect of the present invention according to the above configuration is that the sensor can be mounted on the tire without an adhesive by integrating the container unit with the inner liner of the tire or inner side of the tire.

Since the sensor can be mounted on the tire without an adhesive, when driving at high speed, there is no problem that the adhesive melts due to heat and voids occur.

In addition, since the dummy is used when curing the container unit to the tire, it is possible to prevent the container unit from being deformed and damaged by the pressure applied locally.

In addition, as the pressure of a bladder locally acts non-uniformly at the position where the container unit is formed, there is no problem affecting the tire quality.

It should be understood that the effects of the present invention are not limited to the above-described effects, and include all effects that can be inferred from the configuration of the invention described in the detailed description or claims of the present invention.

### BRIEF DESCRIPTION OF THE DRAWINGS

FIGS. 1 and 2 are exemplary cross-sectional views of a tire manufactured by a method for manufacturing a tire having a sensor container according to an embodiment of the present invention.

FIG. 3 is a flowchart of a method for manufacturing a tire including a sensor container according to an embodiment of the present invention.

FIG. 4 is an exemplary view showing a container unit before curing according to an embodiment of the present invention.

FIG. 5 is an exemplary view showing a container unit after curing according to an embodiment of the present invention.

FIG. 6 is an exemplary view of a tire manufactured by a method for manufacturing a tire having a sensor container equipped with a sensor according to an embodiment of the present invention.

FIG. 7 is an exemplary view showing a dummy according to an embodiment of the present invention.

### DETAILED DESCRIPTION OF THE INVENTION

Hereinafter, the present invention will be described with reference to the accompanying drawings. However, the present invention may be embodied in several different forms, and thus is not limited to the embodiments described herein. Further, in order to clearly explain the present invention in the drawings, parts irrelevant to the description are omitted, and similar reference numerals are attached to similar parts throughout the specification.

Throughout the specification, when it is said that a part is “connected (accessed, contacted, coupled)” with another part, this includes not only the case of “directly connected” but also the case of “indirectly connected” with another member interposed therebetween. In addition, when a part “includes” a certain component, this means that other components may be further included, rather than excluding other components, unless otherwise stated.

The terminology used herein is used only to describe specific embodiments, and is not intended to limit the present invention. The singular expression includes the plural expression unless the context clearly dictates otherwise. In the present specification, terms such as “comprise” or “have” are intended to designate that a feature, number, step, operation, component, part, or combination thereof described in the specification exists, and should be understood that it does not preclude the possibility of addition or existence of one or more other features, numbers, steps, operations, components, parts, or combinations thereof in advance.

Hereinafter, embodiments of the present invention will be described in detail with reference to the accompanying drawings.

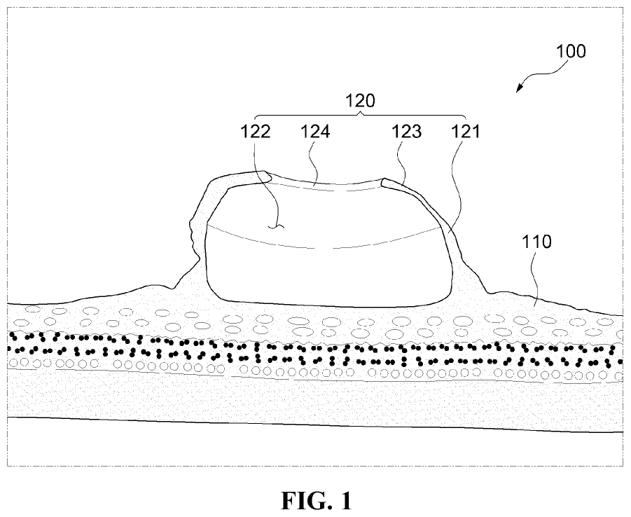

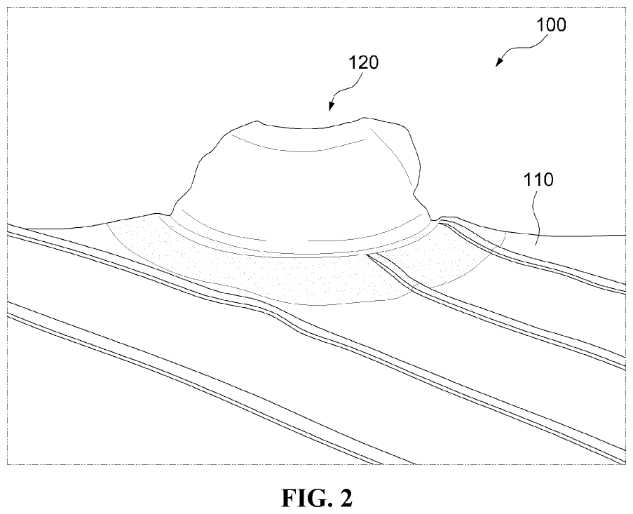

FIGS. 1 and 2 are exemplary cross-sectional views of a tire manufactured by a method for manufacturing a tire having a sensor container according to an embodiment of the present invention.

Referring to FIGS. 1 and 2, a tire 100 manufactured by a method for manufacturing a tire having a sensor container according to the present invention may include a tire 110, a container unit 120, and a sensor 130.

The tire 110 may have an inner region of the tire having an inner liner to which the container unit 120 can be attached.

The container unit 120 is cured and coupled to the tire 110, and may have a container side wall 121, a sensor mounting region 122, a container cover 123, and a sensor insertion hole 124.

The container side wall 121 may be provided such that a lower portion thereof is integrated with the tire 110 during curing. Specifically, the container side wall 121 has a ring-shaped bottom surface that is cured and coupled to the tire 110, and may be formed to have a side wall formed to extend upward from the inner end of the bottom surface to be substantially perpendicular to the tire 110. In this case, the container side wall 121 may be provided in a circular shape in which the inner ring is filled.

When the container side wall 121 provided in this way is cured while attached to the tire 110, the bottom surface may be integrated and fixed with the tire 110.

The sensor mounting region 122 is formed inside the container side wall 121 and may be formed of an empty space having a shape corresponding to the outer shape of the sensor 130.

The container cover 123 is provided to extend from the upper end of the container side wall 121, and may be formed to cover a portion of the upper portion of the container side wall 121.

The sensor insertion hole 124 is formed in the central portion of the container cover 123, and may be provided to form a passage through which the sensor 130 can be inserted.

Here, the diameter of the sensor insertion hole 124 is provided to form a passage through which the sensor 130 can be inserted into the sensor mounting region 122, and the container cover 123 may be formed to fix the sensor 130 inserted into the sensor mounting region 122 not to be detached while driving.

That is, the sensor 130 may be provided to be inserted into the container unit 120 through the sensor insertion hole 124. Further, as long as the container cover 123 is not removed by forcibly spreading both sides, the sensor 130 may be fixed while being inserted into the container unit 120 even during high-speed driving.

The sensor 130 may be provided to be inserted into the container unit 120 to measure information such as tire pressure, wear level, and acceleration.

The container unit 120 thus provided is integrally coupled to the tire 110 without an adhesive, and the sensor 130 may also be mounted inside the container unit 120 without an adhesive.

The sensor 130 is provided to have the same outer shape as a dummy 10, and the shapes of the sensor 130 and inner space of the container unit 120 are provided to be the same. Accordingly, when the sensor 130 is inserted into the container unit 120, the sensor 130 is provided to be in close contact with the inner surface of the container unit 120. Accordingly, the sensor 130 can be stably fixed when inserted into the inner surface of the container unit 120 without an adhesive.

However, when the sensor 130 is inserted into the container unit 120, if necessary, the sensor 130 may be inserted and fixed after applying an adhesive such as a bond to the bottom surface.

In addition, the container unit 120 may be provided with a protrusion formed on the inside, and an insertion groove corresponding to a portion in which the protrusion is formed may be formed on the outer surface of the sensor 130. Accordingly, when the sensor 130 is inserted into the container unit 120, the protrusion is inserted into the insertion groove, so that the fixing effect is further improved. Here, the insertion groove may be formed inside the container unit 120, and the protrusion may be formed in the sensor 130.

Hereinafter, a method for manufacturing a tire having a sensor container will be described.

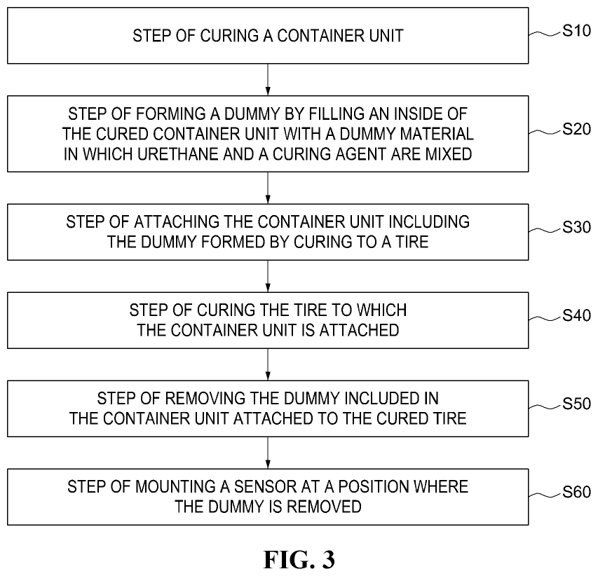

FIG. 3 is a flowchart of a method for manufacturing a tire having a sensor container according to an embodiment of the present invention.

Referring to FIG. 3, in a method for manufacturing a tire having a sensor container, the step (S10) of curing the container unit may be performed first.

In the step (S10) of curing the container unit, the container unit 120 may be prepared to contain 0.1 to 99.5% by weight of a filler material, 0.1 to 99.5% by weight of oil, and 0.001 to 30% by weight of sulfur.

Here, the filler material is made of a rubber-based material formed of a polymer mixture containing natural rubber and synthetic rubber, and it may be made of any one or more of carbon, silica, and organic fillers.

Further, the oil may be a vegetable oil or a petroleum oil.

In the step (S10) of curing the container unit (S10), the container unit 120 may be preferably provided to be cured at 180° C. for 120 seconds, but the temperature and curing time are not limited thereto. That is, in the step (S10) of curing the container unit, the container unit 120 may be provided to be cured at a temperature of 170° C. to 190° C. for 110 seconds to 130 seconds.

After the step (S10) of curing the container unit, the step (S20) of forming a dummy by filling an inside of the cured container unit with a dummy material in which urethane and a curing agent are mixed may be performed.

In the step (S20) of forming a dummy by filling an inside of the cured container unit with a dummy material in which urethane and a curing agent are mixed, first, the dummy material may be formed by mixing the urethane having a hardness of 1 to 100 and a curing agent in a ratio of 2:8 to 8:2. In addition, the dummy material may be poured into the sensor mounting region 122 of the container unit 120 to fill the inside of the sensor mounting region 122. The dummy material filled in the sensor mounting region 122 may be provided to be cured for 3 minutes.

After the step (S20) of forming a dummy by filling an inside of the cured container unit with a dummy material in which urethane and a curing agent are mixed, the step (S30) of attaching the container unit including the dummy formed by curing to a tire may be performed.

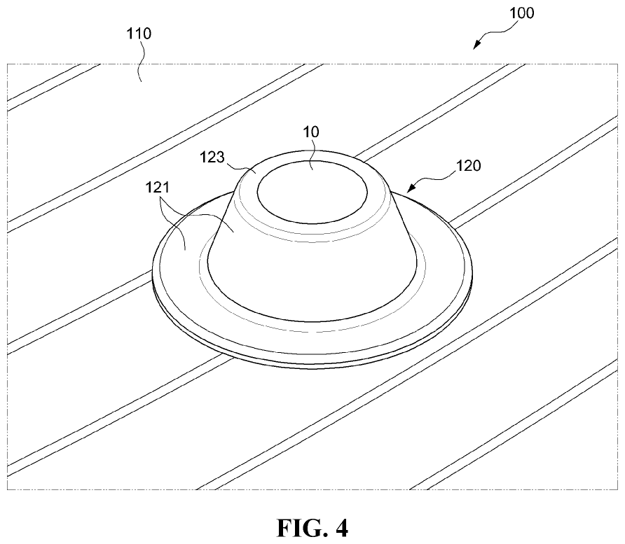

FIG. 4 is an exemplary view showing a container unit before curing according to an embodiment of the present invention.

Further referring to FIG. 4, in the step (S30) of attaching the container unit including the dummy formed by curing to a tire, the container unit 120 may be provided to be attached to any point inside the tire 110 having an inner liner.

Here, the tire 110 is a tire in a state in which only molding is performed without curing.

After the step (S30) of attaching the container unit including the dummy formed by curing to a tire, the step (S40) of curing the tire to which the container unit is attached may be performed.

In the step (S40) of curing the tire to which the container unit is attached, curing may be performed such that the container unit 120 has the hardness of 10 to 100 and the 100% modulus of 50 kgf/cm² or less.

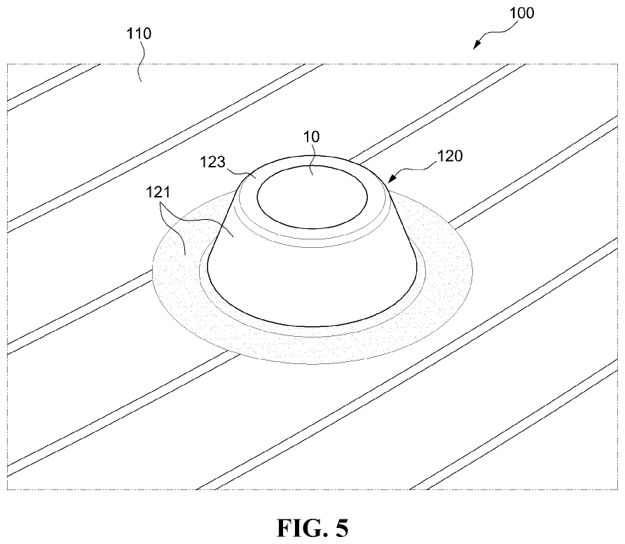

FIG. 5 is an exemplary view showing a container unit after curing according to an embodiment of the present invention.

As shown in FIG. 5, when the curing is performed in the step (S40) of curing the tire to which the container unit is attached, the bottom surface of the container side wall 121 may be integrated and fixed with the tire 110.

After the step (S40) of curing the tire to which the container unit is attached, the step (S50) of removing the dummy included in the container unit attached to the cured tire may be performed.

In the step (S50) of removing the dummy included in the container unit attached to the cured tire, the dummy 10 included in the container unit 120 may be removed by slightly spreading the container cover 123.

After the step (S50) of removing the dummy included in the container unit attached to the cured tire, the step (S60) of mounting a sensor at a position where the dummy is removed may be performed.

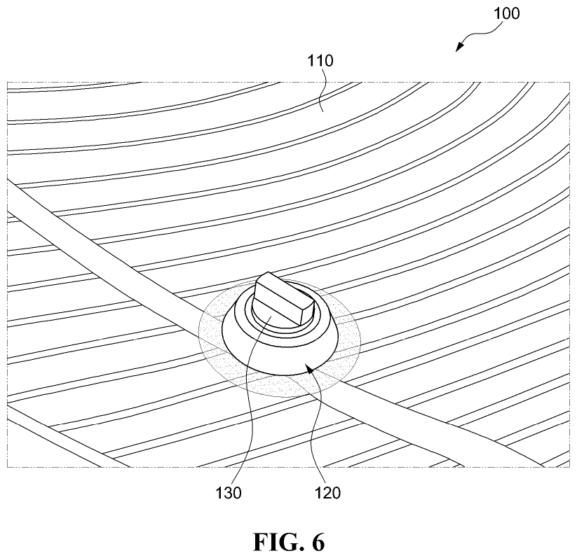

FIG. 6 is an exemplary view of a tire manufactured by a method for manufacturing a tire having a sensor container equipped with the sensor according to an embodiment of the present invention.

Referring to FIG. 6, in the step (S60) of mounting the sensor at a position where the dummy is removed, the sensor 130 may be inserted into the container unit 120 without applying an adhesive.

Specifically, in the step (S60) of mounting the sensor at a position where the dummy is removed, the sensor 130 is inserted into the sensor mounting region 122 through the sensor insertion hole 124 without an adhesive.

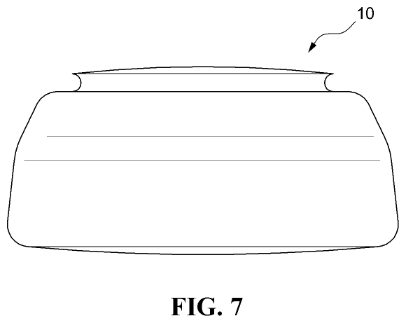

FIG. 7 is an exemplary view showing a dummy according to an embodiment of the present invention.

As shown in FIG. 7, after in the step (S60) of mounting the sensor at a position where the dummy is removed, the removed dummy 10 may be recycled thereafter.

Specifically, the step (S10) of curing the container unit and the step (S20) of forming a dummy by filling an inside of the cured container unit with a dummy material in which urethane and a curing agent are mixed for forming the dummy 10 may be omitted, and the dummy may be recycled in the step (S30) of attaching the container unit having the dummy formed by curing to the tire and the step (S40) of curing the tire to which the container unit is attached.

The dummy thus formed may be used for more than 200 cycles.

After attaching the container unit 120 having the sensor 130 to the inside of the 280/680R18 F200 tire 110, a high-speed endurance driving test was performed at a camber of 4 degrees, a load of 350 kg, and 200 km/h. As a result, there was no problem of the sensor 130 detaching from the container unit 120 or the tire 110, and no sensor detachment problem or sensor recognition problem occurred even during actual driving at a speed of 290 km/h for 2 hours.

The present invention thus prepared has an effect that the sensor 130 can be stably mounted on the tire without an adhesive by integrating the container unit 120 with the inner liner or inner side of the tire.

In addition, according to the present invention, since the sensor 130 can be mounted on the tire 110 without an adhesive, there is no problem in that the adhesive is melted due to heat and voids occur during high-speed driving.

In addition, according to the present invention, since the dummy is used when the container unit 120 is cured to the tire 110, it is possible to prevent the container unit 120 from being deformed and damaged due to a locally applied pressure, etc.

As a result of checking the cross-section of the actual tire, there was no phenomenon in which the portion where a bladder did not touch between the bottom surface to which the sensor container unit 120 was attached and the inner portion of the tire 110 was not cured. It was confirmed that there was no difference between the physical properties of the tread rubber at the position vertically lowered to the outside the tire 110 from the portion where the container unit 120 is attached and the physical properties of the tread rubber positioned next to it and not affected by the container unit 120. In addition, when the bladder pushed the inside of the tire 110, it was expected that there would be a deformation in the arrangement of the nylon and steel cords in the region pressed by the dummy, but as shown in FIG. 1, it was confirmed that no deformation occurred when compared with other regions.

In addition, as a result of checking whether the bladder was damaged after curing, no deformation of the bladder was found after 200 cycles, and the change in the expansion pressure of the bladder during curing was not different from that when the container unit 120 was not attached.

The dummy used in the container unit 120 maintained the profile shape in the container rubber without damage even at high temperature and high pressure, and the dummy did not show any deformation of the profile or change in hardness even when used for 200 cycles (times).

The above description of the present invention is for illustrative purposes, and those of ordinary skill in the art to which the present invention pertains will be able to understand that the embodiment can be easily transform into other specific forms without changing the technical spirit or essential features of the present invention. Therefore, it should be understood that the embodiments described above are illustrative in all respects and not restrictive. For example, each component described as a single type may be implemented in a dispersed form, and likewise components described as dispersed may be implemented in a combined form.

The scope of the present invention is indicated by the following claims, and all changes or modifications derived from the meaning and scope of the claims and their equivalents should be interpreted as being included in the scope of the present invention.

### DESCRIPTION OF REFERENCE NUMERALS

100: tire manufactured by a method for manufacturing a tire having a sensor container
110: tire
120: container unit
121: container side wall
122: sensor mounting region
123: container cover
124: sensor insertion hole
130: sensor

What is claimed is:

1. A method for manufacturing a tire comprising a sensor container, the method comprising the steps of:
a) curing a container unit;
b) forming a dummy by filling an inside of the cured container unit with a dummy material in which urethane and a curing agent are mixed;
c) attaching the container unit including the dummy formed by curing, to a tire;
d) curing the tire to which the container unit is attached;
e) removing the dummy included in the container unit attached to the cured tire; and
f) mounting a sensor at a position where the dummy is removed.

2. The method according to claim 1, wherein in the step a), the container unit is prepared to contain 0.1 to 99.5% by weight of a filler material, 0.1 to 99.5% by weight of oil, and 0.001 to 30% by weight of sulfur.

3. The method according to claim 2, wherein the filler material is made of a rubber-based material formed of a polymer mixture containing natural rubber and synthetic rubber, and is made of any one or more of carbon, silica, and organic filler.

4. The method according to claim 2, wherein the oil is a vegetable oil or a petroleum oil.

5. The method according to claim 1, wherein in the step a), the container unit is provided to be cured at a temperature of 170° C. to 190° C. for 110 seconds to 130 seconds.

6. The method according to claim 1, wherein in the step b), the dummy material is formed by mixing the urethane having a hardness of 1 to 100 and the curing agent in a ratio of 2:8 to 8:2.

7. The method according to claim 1, wherein in the step c), the container unit is provided to be attached to any point inside the tire having an inner liner.

8. The method according to claim 1, wherein in the step d), the curing is performed such that the container unit has a hardness of 10 to 100 and 100% modulus of 50 kgf/cm² or less.

9. The method according to claim 1, wherein in the step f), the sensor is provided to be inserted into the container unit without applying an adhesive.

10. The method according to claim 1, wherein after the step f), the removed dummy is provided to be recycled in the step c) and the step d) by omitting the step a) and the step b).

11. A tire manufactured by the method of manufacturing a tire comprising a sensor container according to claim 1, comprising:
the container unit cured and coupled to the tire; and
the sensor inserted into the container unit.

12. The tire according to claim 11, wherein the container unit includes:
a container side wall provided such that a lower portion of the container side wall is integrated with the tire during the curing;
a sensor mounting region formed inside the container side wall and formed of an empty space having a shape corresponding to an outer shape of the sensor;
a container cover formed to cover an upper portion of the container side wall; and
a sensor insertion hole formed in a central portion of the container cover.

13. The tire according to claim 12, wherein a diameter of the sensor insertion hole is provided to form a passage through which the sensor is inserted into the sensor mounting region and the container cover is formed to fix the sensor inserted into the sensor mounting region not to be detached while driving.
